(19) United States
(12) Patent Application Publication
(10) Pub. No.: US 2026/0167523 A1
(43) Pub. Date: Jun. 18, 2026

(54) METHOD AND SYSTEM FOR INFUSING A FREQUENCY INTO WATER

(71) Applicant: Love Tuner, Inc., Malibu, CA (US)

(72) Inventor: Sigmar Berg, Malibu, CA (US)

(21) Appl. No.: 18/981,298

(22) Filed: Dec. 13, 2024

(51) Int. Cl. C02F 1/00; C02F 1/34

(52) U.S. Cl. CPC C02F 1/005; C02F 1/34

(57) ABSTRACT

The invention relates to a method and system for infusing a desired vibrational frequency into water to alter its molecular structure and enhance its properties. The system includes a frequency generator that produces the desired vibrational frequency, which is then transmitted through a suitable medium to water contained in a specialized unit. The infused water exhibits altered properties, making it suitable for various applications, including health, agriculture, and industrial processes. The process allows for precise control over the 528 hz frequency, exposure time, and other parameters, ensuring consistent and repeatable results.

### FIELD OF THE INVENTION

The present invention pertains to the field of water treatment, specifically to methods and systems for infusing a frequency into water to modify its molecular structure and enhance its properties. More specifically, the present application relates to methods and systems for infusing one of the frequencies selected from the group consisting of 136 Hertz (Hz), 396 Hz, 417 Hz, 432 Hz, 528 Hz, 639 Hz, 741 Hz, and 852 Hz into water to modify its molecular structure and enhance its properties. Even more specifically, to methods and systems for infusing the 528hz frequency into water to modify its molecular structure and enhance its properties. This invention has applications in health, agriculture, and various industrial processes.

### BACKGROUND

Traditional water treatment methods focus on chemical, mechanical, or thermal processes to purify, filter, or enhance water for different applications. While effective, these methods often involve significant costs, environmental impact, and complex machinery. Frequency-based water treatment, a more recent development, offers a non-invasive alternative by altering the molecular properties of water without the need for chemical additives or complex mechanical systems.

Existing technologies, such as those described in US20070157791A1, involve the infusion of specific frequencies into water to achieve structural modifications. However, these methods may be limited by the range of frequencies used, inefficiencies in the infusion process, and inconsistent results due to a lack of precise control over the treatment parameters.

Accordingly, there is a need for an advanced system that offers precise control over the frequency infusion process, ensuring consistent and repeatable results. Such a system should be adaptable to various applications, from enhancing water for human consumption to optimizing agricultural yields and improving industrial processes. The present invention addresses these needs by providing a method and system that enhances the molecular properties of water through controlled frequency infusion, offering a versatile and effective solution for diverse water treatment challenges.

### SUMMARY

The present invention provides a method and system for infusing specific frequencies into water, thereby altering its molecular structure and enhancing its properties for various applications. The invention comprises a frequency generator capable of producing one of the frequencies selected from the group consisting of 136 Hertz (Hz), 396 Hz, 417 Hz, 432 Hz, 528 Hz, 639 Hz, 741 Hz, and 852 Hz within a specified range, a transmission medium that conveys the frequency to water, and a containment unit where the water is treated. In particular, the system is designed for use with the 528 Hz

The method involves generating the frequency, such as 528 Hz, which is then transmitted through a medium such as electromagnetic or acoustic waves. The water, contained within a specialized unit, is exposed to the 528 hz frequency, leading to modifications in its molecular configuration. These modifications result in enhanced characteristics of the water, making it suitable for diverse applications, including health and wellness, agriculture, and industrial processes.

The system ensures consistent and repeatable results by incorporating sensors and control mechanisms that monitor and adjust process parameters. This precise control allows the treated water to meet specific requirements for each intended application.

The methods described herein teach how to infuse water with a specific vibrational frequency, ensuring that the desired frequency is precisely transmitted and maintained. In preferred embodiments, the process begins by placing water into a suitable container. It's essential to confirm that the container itself does not interfere with or alter the vibrational frequency being introduced to the water.

A frequency generator is then used to produce only the desired frequency, which is transmitted into both the container and the water continuously for a specified duration of time, with the amplitude adjusted to a precise level. The process may include monitoring the vibrational frequency to ensure it stays within acceptable frequency and amplitude limits. This monitoring can be enhanced by using a hydrophone, which may be used to accurately monitor both frequency and amplitude in real time.

In preferred embodiments, a feedback system may be used such that when the monitoring system detects a departure from the frequency or amplitude of the desired vibrational frequency, the generator is instructed to immediately correct the output.

The frequency used in this method can vary depending on the desired effect, with preferred options including 136 Hz, 396 Hz, 417 Hz, 432 Hz, 528 Hz, 639 Hz, 741 Hz, and 852 Hz. A particularly popular frequency for this process is 528 Hz. To ensure even exposure throughout the water, the liquid may be circulated continuously inside the container during the frequency transmission.

In some implementations, an amplifier may be used to increase the amplitude of the frequency signal. The duration of exposure can vary, typically falling within a defined range, and the amplitude may also be adjusted to fall between specific decibel levels, depending on the intended outcome.

Systems have also been developed to infuse the desired vibrational frequency into water. The system consists of a water-filled container paired with a frequency generator, capable of emitting only the desired vibrational frequency for a specified amount of time and at a set amplitude. In more advanced versions, the system can include a hydrophone for real-time monitoring, ensuring the water consistently receives the intended frequency and amplitude.

The hydrophone also helps detect any deviations, enabling the system to maintain precise frequency output throughout the process. Additional sensors and control mechanisms allow for dynamic adjustments to frequency, amplitude, and exposure time, ensuring consistency and repeatability in every application.

For optimal performance, the frequency generator's output may be amplified to achieve the necessary amplitude. The system supports a range of frequencies, including the same set used in the manual process, such as 528 Hz, which is often preferred for its specific properties. Depending on the setup, the system can fine-tune the amplitude to fall within a specified decibel range, ensuring the water receives the exact vibrational energy required.

### BRIEF DESCRIPTION OF THE DRAWINGS

FIG. 1 illustrates a system for infusing water with a specific frequency of vibration;

FIG. 2 illustrates a method of infusing water with a specific frequency of vibration.

### DETAILED DESCRIPTION OF THE EMBODIMENTS

The present invention relates to methods and systems for the infusion of a specific frequency into water, resulting in altered molecular structure and enhanced properties. More specifically, the present application relates to methods and systems for infusing one of the frequencies into water. The methods and systems herein can be used with any frequency. In preferred embodiments, the frequency infused in the water is selected from the group consisting of 136 Hertz (Hz), 396 Hz, 417 Hz, 432 Hz, 528 Hz, 639 Hz, 741 Hz, and 852 Hz into water to modify its molecular structure and enhance its properties. Even more specifically, the present application relates to methods and systems for infusing the 528 hz frequency into water to modify the molecular structure of water and enhance its properties.

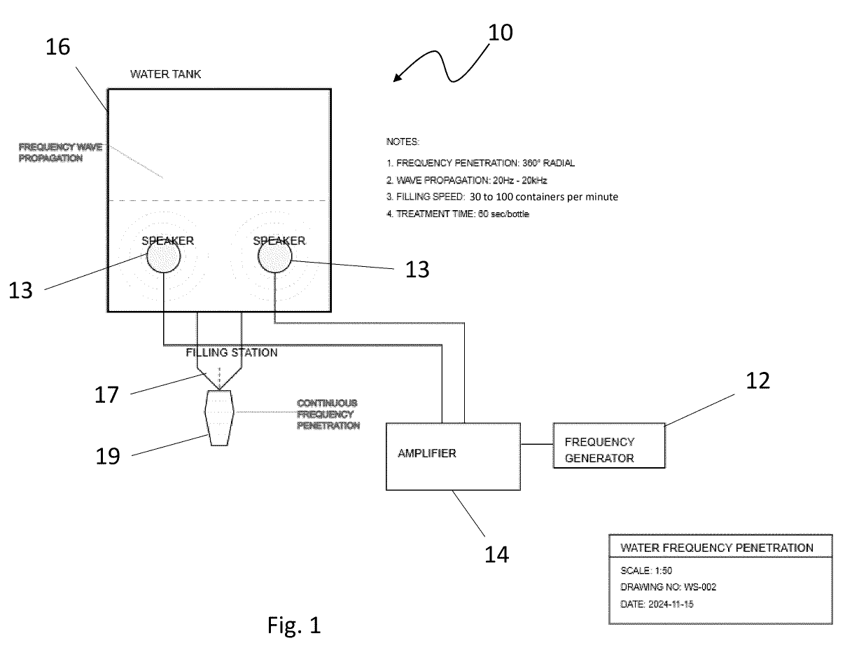

FIG. 1 illustrates a system 10 for infusing water with a specific frequency of vibration. To transmit a frequency of vibration into water, a frequency generator 12 and/or sound devices 12 are required. Regardless of the device, the frequency generator 12 needs to be capable of creating the desired frequency, e.g., 528 Hz, and other known healing frequencies such as 396 Hz, 417 Hz, 432 Hz, 528 Hz, 639 Hz, 741 Hz, and 852 Hz. Although these frequencies are known to have benefits, other frequencies may be used depending on the embodiment and the benefits desired.

In preferred embodiments, the frequency generator 12 is configured to produce the 528 Hz frequency. This frequency has been selected based on its effectiveness in modifying the water's molecular structure to achieve the desired outcomes. In preferred embodiments, the generator 12 includes digital controls that allow for precise tuning of the frequency, amplitude, and duration of the signal.

In some embodiments, an amplifier 14 may be in electrical communication with the frequency generator 12 to boost the signal if the signal is too weak. While an amplifier 14 is not necessarily required, it can help achieve the proper amplitude in some embodiments. The output of the frequency generator 12 and/or amplifier 14 is connected to speakers 13 to create the 528 Hz sound. One or more speakers 13 may be used. As may be seen in FIG. 1, a plurality of speakers are located within the water to be modified.

In preferred embodiments, the amplitude of the signal is 30 decibels or greater when it contacts the water. In other embodiments, the amplitude of the signal is 40 decibels or greater when the signal contacts the water. In even more preferred embodiments, the amplitude of the signal is 50 decibels or greater and less than 180 decibels when the signal contacts the water.

Transducer devices 13 may be used to convert the electrical signal into mechanical vibrations or sound waves that will interact with the water. Depending on the container 16 filled with water where the frequency will be transmitted, a hydrophone can optionally be installed to measure the effect of sound in the water.

By connecting the frequency generator 12 to an amplifier 14, the signal strength is ensured to be sufficient to vibrate the water. When the desired frequency on the generator 12 or sound device is set, and the amplitude is sufficient, the desired frequency may then be transmitted into the water.

The water may be subjected to the desired frequency for any amount of time. In preferred embodiments, the water is continuously subjected to the frequency for at least 30 seconds to 1 minute. Continuously, without interruption, subjecting the water to the frequency for at least one minute ensures the molecular structure of the water is sufficiently altered to retain the effect of the frequency exposure. Although any amount of time may technically be used, for efficiency, 60 minutes or less is sufficient. In other embodiments, the water is subjected to the frequency continuously from 1-10 minutes. In even more preferred embodiments, the water may be subjected to the frequency continuously from 1-5 minutes and more preferably from 1-2 minutes.

Transducers 13 can be air speakers or submersible transducers. For direct transmission into water, waterproof transducers or underwater speakers 13 may be used. The transducers will convert the electrical signal into sound waves or vibrations, which propagate through the water. The water molecules will vibrate at the same frequency as the signal absorbing the frequency.

In some embodiments, a hydrophone may be used to check the sound wave propagation in the water. The physical effects on the water, such as ripples or vibrations, may also indicate successful transmission.

The frequency generated by this method can be effectively transmitted into water, given the ability of water molecules to exhibit tendencies and structural changes after exposure.

Transmission Medium—The medium for transmitting the frequency can vary depending on the application. In some embodiments it can be air or another liquid. In other embodiments, the transducer 13 may be placed directly into the water or coupled to the container 16 containing the water. As may be seen in FIG. 1, the water is in a large container 16.

In some embodiments, the water may be bottled ready for distribution and then subjected to the selected frequency. In other embodiments, the water may first be subjected to the frequency in larger vats 16 such as the one shown in FIG. 1, and then bottled for distribution. As may be seen in FIG. 1, a fill valve 17 is on the bottom side of the container 16 and allows for direct filling of the bottles 19 for distribution.

In preferred embodiments, the mechanical waves are acoustic waves: Acoustic waves are effective for embedding specific vibrational properties into the water, particularly for agricultural uses.

Containment and Circulation: In preferred embodiments, the containment unit 16 must be constructed from materials that do not interact with the transmitted frequency, ensuring the water's properties are altered only by the intended frequency. For example, the container 16 should only vibrate at the desired frequency and it should be insured that the container 16 does not create a resonance at the desired frequency because it would alter the effects of the process. For systems 10 that subject the water to the desired frequency in large vats as part of continuous processing, the system 10 may include a pump that circulates the water during treatment, ensuring uniform exposure to the frequency.

### Process Control

In preferred embodiments, the system 10 is equipped with sensors and control software to monitor process parameters such as temperature, exposure time, and frequency stability and amplitude. This ensures that the infusion process is consistent and meets the required specifications for each batch of treated water.

### Outcomes

Health Applications: Treated water demonstrates improved cellular uptake, making it beneficial for consumption.

Agricultural Applications: Plants watered with frequency-infused water show faster growth and higher yields.

Industrial Applications: The infused water enhances chemical reactions, reduces scale buildup, and improves cleaning processes.

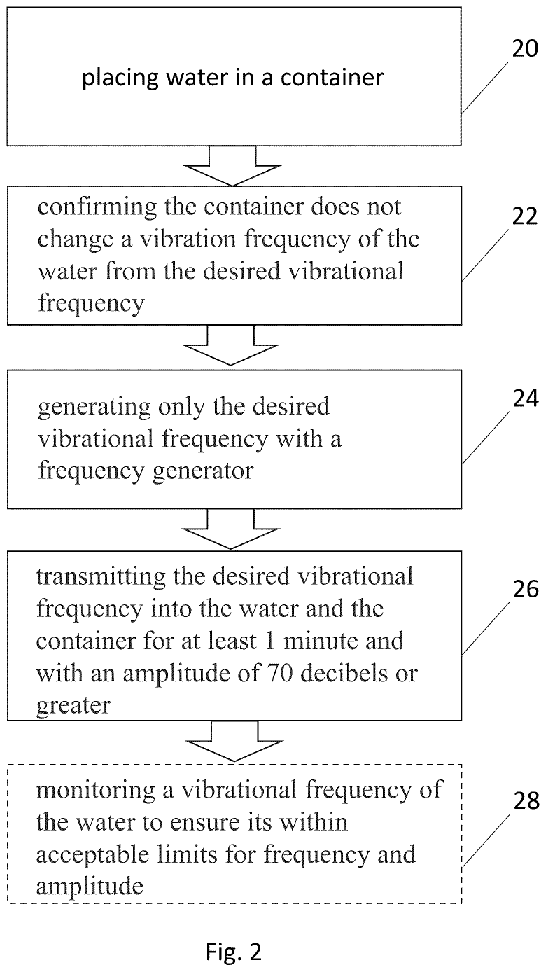

FIG. 2 illustrates a method of infusing water with a specific frequency of vibration. In preferred embodiments of the method, the method begins by placing water in a container in step 20. It should be confirmed that the container does not change a vibration frequency of the water from the desired vibrational frequency in step 22. This may be done once during system design or repeatedly depending on the type of container. In preferred embodiments, the method proceeds by generating only the desired vibrational frequency with a frequency generator in step 24. In preferred embodiments, the frequency generator may be set and checked periodically. In even more preferred embodiments, the system includes sensors that monitor the frequency being generated and provides feedback to the frequency generator, which may be adjusted in real time. Preferably, the frequency generated is held in a tight tolerance to the desired frequency.

The method proceeds with step 26 by transmitting the desired vibrational frequency into the water and the container for at least 1 minute and with an amplitude of at least 70 decibels or greater. As a general principle, due to the significantly higher density of water compared to air, an additional 61.5 decibels of sound pressure is required to achieve the same level of acoustic transmission. Some embodiments include optional step 28 of monitoring a vibrational frequency of the water to ensure its within acceptable limits for frequency and amplitude.

This system is designed to be used in various industries, including health, agriculture, and industrial processes, where such modified water can provide significant benefits. Our bodies are made of 98% water and water is essential for our lives and bodies. Besides the physical effects and benefits we obtain from frequency infused water, certain frequencies, e.g., 528 Hz, have the ability to affect the body, mind, and spirit through frequency-enhanced water, and its ability to connect us with nature and the universe.

What is claimed is:

1. A method for infusing a desired vibrational frequency into water, comprising:
placing water into a container;
confirming the container does not change a vibration frequency of the water from the desired vibrational frequency; and
generating only the desired vibrational frequency with a frequency generator.

2. The method for infusing a desired vibrational frequency into water of claim 1, further comprising monitoring a vibrational frequency of the water to ensure its within acceptable limits for frequency and amplitude.

3. The method for infusing a desired vibrational frequency into water of claim 1, wherein the desired vibrational frequency is selected from the group consisting of 136 Hz, 396 Hz, 417 Hz, 432 Hz, 528 Hz, 639 Hz, 741 Hz, and 852 Hz.

4. The method for infusing a desired vibrational frequency into water of claim 1, wherein the desired vibrational frequency is 528 Hz.

5. The method for infusing a desired vibrational frequency into water of claim 1, further comprising continuously circulating the water in the container to ensure its uniformly exposed to the desired vibrational frequency.

6. The method for infusing a desired vibrational frequency into water of claim 1, wherein the amplitude is increased with an amplifier.

7. The method for infusing a desired vibrational frequency into water of claim 2, wherein a hydrophone is used for monitoring the vibrational frequency of the water.

8. The method for infusing a desired vibrational frequency into water of claim 1, wherein the desired vibrational frequency is transmitted into the water for between one minute and 60 minutes.

9. The method for infusing a desired vibrational frequency into water of claim 1, wherein the desired vibrational frequency is transmitted into the water for between 1 minutes and 10 minutes.

10. The method for infusing a desired vibrational frequency into water of claim 1, wherein the desired vibrational frequency is transmitted into the water with an amplitude between 30 decibels and 180 decibels.

11. The method for infusing a desired vibrational frequency into water of claim 1, wherein the desired vibrational frequency is transmitted into the water with an amplitude between 70 decibels and 120 decibels.

12. A system for infusing a desired vibrational frequency into water, comprising:
a container of water; and
a frequency generator configured to produce the desired vibrational frequency only;
wherein the system is configured to infuse the desired vibrational frequency into the water within the container.

13. The system for infusing a desired vibrational frequency into water of claim 12, further comprising a hydrophone configured to monitor a frequency of vibration experienced by the water in the container.

14. The system for infusing a desired vibrational frequency into water of claim 13, wherein the hydrophone is further configured to monitor an amplitude of the frequency of vibration experienced by the water in the container.

15. The system for infusing a desired vibrational frequency into water of claim 12, wherein the desired vibrational frequency is selected from the group consisting of 136 Hz, 396 Hz, 417 Hz, 432 Hz, 528 Hz, 639 Hz, 741 Hz, and 852 Hz.

16. The system for infusing a desired vibrational frequency into water of claim 12, wherein the desired vibrational frequency is 528 Hz.

17. The system for infusing a desired vibrational frequency into water of claim 12, further comprising sensors and control mechanisms that monitor and adjust frequency, amplitude and exposure time of the frequency generator to ensure consistent and repeatable results.

18. The system for infusing a desired vibrational frequency into water of claim 12, further comprising an amplifier configured to amplify the desired vibrational frequency output by the frequency generator.
